(19) United States
(12) Patent Application Publication
(10) Pub. No.: US 2009/0243850 A1
(43) Pub. Date: Oct. 1, 2009

(54) MICROWAVE RECEIVER AND MICROWAVE SENSOR SYSTEM

(76) Inventor: Yoshiteru Nishizato, Fussa-shi (JP)

Correspondence Address: BACON & THOMAS, PLLC, 625 SLATERS LANE, FOURTH FLOOR, ALEXANDRIA, VA, 22314-1176, US

(21) Appl. No.: 12/210,248

(22) Filed: Sep. 15, 2008

(30) Foreign Application Priority Data
Apr. 1, 2008 (JP) 2008-094783

(51) Int. Cl. G08B 13/00

(52) U.S. Cl. 340/541

(57) ABSTRACT

A microwave receiving apparatus according to an embodiment of the invention includes a local transmitter which supplies a local signal having a frequency according to a supplied voltage, a mixer which combines a received microwave signal with the local signal to supply an intermediate frequency signal, a filter which passes the intermediate frequency signal, a phase shifter which shifts a phase of the intermediate frequency signal passed through the filter by a predetermined angle, and a phase detection unit which supplies a voltage to the local oscillator according to a phase difference between the intermediate frequency signal passed through the filter and output of the phase shifter.

### CROSS-REFERENCE TO RELATED APPLICATIONS

This application is based upon and claims the benefit of priority from prior Japanese Patent Application No. 2008-094783, filed Apr. 1, 2008, the entire contents of which are incorporated herein by reference.

### BACKGROUND OF THE INVENTION

1. Field of the Invention

One embodiment of the invention relates to a microwave sensor system including a microwave transmitter and a microwave receiver which receives a microwave radio wave. Particularly the invention relates to a microwave sensor system having a microwave transmitter and a microwave receiver including an Automatic Frequency Control (AFC) circuit which corrects a fluctuation in frequency caused by a temperature characteristic of a microwave oscillator.

2. Description of the Related Art

In a department store and a factory, various security systems, in which the microwave sensors are disposed in plural sites such as an unmanned entrance door, a gate, and a fence where the burglar or intruder might break in and an intrusion alarm from the microwave sensor is detected, are put to practical use instead of deploying many security guards to monitor the burglary or intruder in the night.

Jpn. Pat. Appln. KOKAI Publication No. 2003-329769 discloses a microwave sensor used in the security system. In the disclosed microwave sensor, a microwave transmitter always sends a microwave radio wave to a detection area, a microwave receiver placed at a position facing the detection area receives the radio wave to detect a disturbance of an electric field formed by the microwave, and to send the intrusion alarm.

However, in the microwave sensor, oscillators are mounted on the microwave transmitter and the microwave receiver, and usually the oscillators cause the fluctuation in frequency due to a temperature change to have an influence on wave detection accuracy on the reception side.

Additionally, in the conventional microwave sensor, the wave detection accuracy is lowered by the fluctuation in frequency, which possibly issuing a false alarm.

### BRIEF SUMMARY OF THE INVENTION

An object of the invention is to provide a microwave receiver in which the wave detection accuracy is enhanced by avoiding the influence of the fluctuation in frequency of the oscillator.

In accordance with a first embodiment of the invention, a microwave receiver apparatus includes a local transmitter which supplies a local signal having a frequency according to a supplied voltage; a mixer which combines a received microwave signal with the local signal to supply an intermediate frequency signal; a filter which passes the intermediate frequency signal; a phase shifter which shifts a phase of the intermediate frequency signal passed through the filter by a predetermined angle; and a phase detection unit which supplies a voltage to the local oscillator according to a phase difference between the intermediate frequency signal passed through the filter and output of the phase shifter.

In accordance with a second embodiment of the invention, a microwave sensor system includes a transmitter which transmits a microwave from a transmission antenna, the transmission antenna being disposed one side of a detection area; and a receiver which includes a reception antenna, the reception antenna being disposed on the other side of the detection area while facing the transmission antenna, the receiver having a local transmitter which supplies a local signal having a frequency according to a supplied voltage; a mixer which combines a received microwave signal with the local signal to supply an intermediate frequency signal; a filter which passes the intermediate frequency signal; a phase shifter which shifts a phase of the intermediate frequency signal passed through the filter by a predetermined angle; and a phase detection unit which supplies a voltage to the local oscillator according to a phase difference between the intermediate frequency signal passed through the filter and output of the phase shifter.

Accordingly, in the microwave receiver and microwave sensor system of the invention, advantageously the wave detection accuracy is enhanced by avoiding the influence of the fluctuation in frequency of the oscillator.

### BRIEF DESCRIPTION OF THE SEVERAL VIEWS OF THE DRAWING

FIG. 1 shows a configuration of a microwave sensor system according to an embodiment of the invention;

FIG. 2 is a circuit diagram showing an example of an elliptic function filter circuit;

FIG. 3 is a graph showing an example of a filter characteristic of an elliptic function filter;

FIG. 4 is a circuit diagram showing an example of a phase shifter circuit;

FIG. 5 is a view explaining an operation of a wide-band AFC circuit according to an embodiment of the invention; and

FIG. 6 is a graph showing a phase characteristic of an elliptic function filter.

### DETAILED DESCRIPTION OF THE INVENTION

Various embodiments according to the invention will be described hereinafter with reference to the accompanying drawings.

An embodiment of the invention will be described below with reference to the drawings.

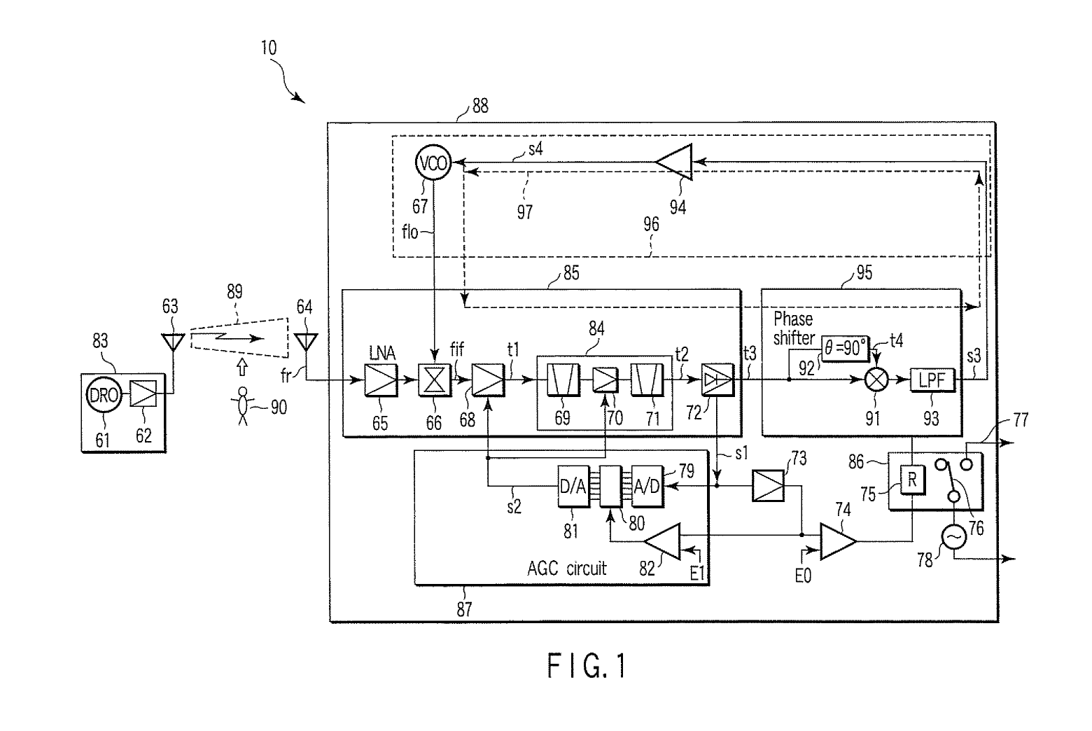

FIG. 1 shows a configuration of a microwave receiver and microwave sensor system according to an embodiment of the invention.

(Configuration)

A microwave sensor system 10 includes a transmitter 83 and a receiver (microwave receiver) 88. As shown in FIG. 1, the transmitter 83 includes a microwave oscillator 61 such as a dielectric resonant oscillator (DRO), an amplifier 62 to which an output end of the microwave oscillator 61 is connected, and a transmission antenna 63 which is connected to the amplifier 62.

The receiver 88 includes a reception detection circuit 85 to which the reception antenna 64 is connected, a phase detection circuit 95 to which output of the reception detection circuit 85 is supplied, a wide-band Automatic Frequency Control (AFC) circuit 96, and an Automatic Gain Control (AGC) circuit 87 which controls a gain of the reception detection circuit 85. The receiver 88 also includes a direct-current amplifier 73 which receives an output signal from the reception detection circuit 85, a comparator 74 which is connected to the direct-current amplifier 73, a relay circuit 86 which receives output of the comparator 74, and a power supply 78.

The relay circuit 86 includes a relay excitation coil 75 which is energized by the output of the comparator 74 and a relay contact 76 which is turned on and off according to the relay excitation coil 75.

In the reception detection circuit 85, the reception antenna 64 is connected to an input end of an amplifier 65, an output end of the amplifier 65 is connected to one of input ends of a mixer 66, and an output end of a Voltage Control Oscillator (VCO) 67 of a local oscillator is connected to the other input end of the mixer 66. An output end of the mixer 66 is connected to an input end of an amplifier 68, and an output end of the amplifier 68 is connected to an input end of a filter 69 such as an elliptic function filter, and an output end of the filter 69 is connected to an input end of an amplifier 70. An output end of the amplifier 70 is connected to an input end of a filter 71 such as an elliptic function filter, and an output end of the filter 71 is connected to an input end of a wave detector (rectifier) 72.

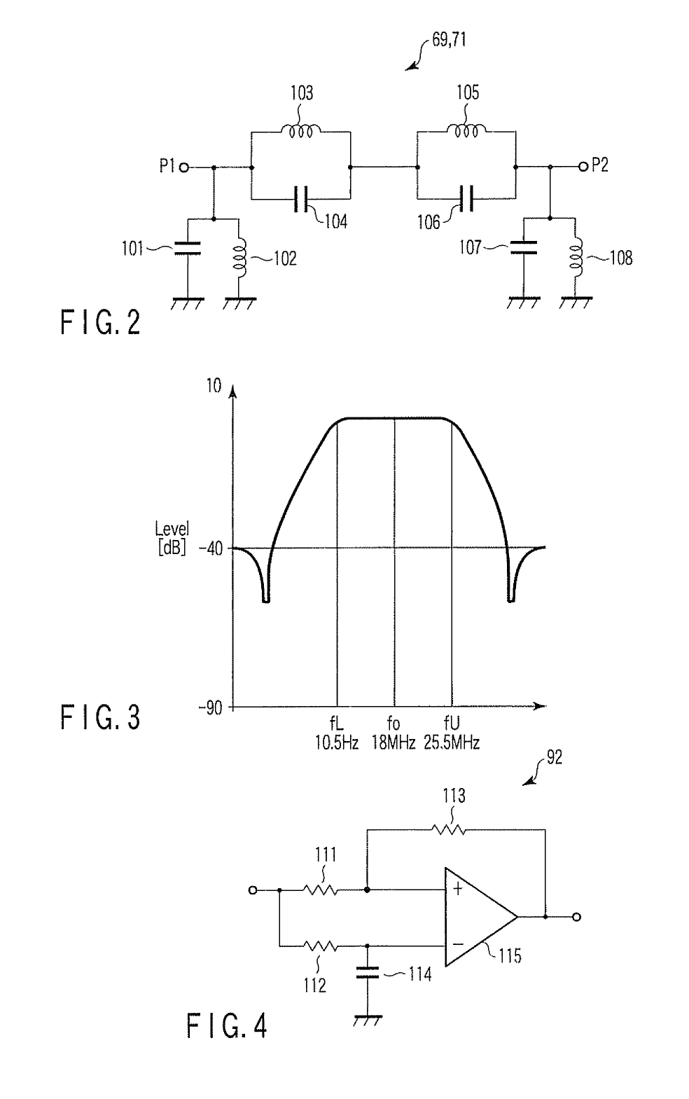

The elliptic function filter is used as the filters 69 and 71. FIG. 2 shows an example of the elliptic function filter, and FIG. 3 shows an example of an filter characteristic (pass band) of the elliptic function filter. As can be seen from the filter characteristic of FIG. 3, the elliptic function filter is a filter suitable to obtain a constant characteristic in a wide band. That is, a microwave signal used in the microwave sensor system has a frequency of 24.15 GHz, and the fluctuation in frequency caused by a temperature characteristic of an oscillator in the transmitter is generated as large as tens megahertz. Accordingly, desirably the filter which deals with an intermediate frequency has a trapezoidal characteristic which exerts a constant value in a wide frequency band as shown in FIG. 3.

Each of the filters 69 and 71 includes a capacitor 101 in which one end is grounded while the other end is connected to an input terminal P1, a coil 102 in which one end is grounded while the other end is connected to the input terminal P1, a coil 103 in which one end is connected to the input terminal P1, and a capacitor 104 in which one end is connected to the input terminal P1. Each of the filters 69 and 71 also includes a coil 105 whose one end is connected to the other end of the coil 103 and the other end of the coil 104, a capacitor 106 whose one end is connected to the other end of the coil 103 and the other end of the capacitor 104, a capacitor 107 in which one end is connected to the other end of the coil 105, the other end of the capacitor 106, and an output terminal P2 while the other end is grounded, and a coil 108 in which one end is connected to the other end of the coil 105, the other end of the capacitor 106, and the output terminal P2 while the other end is grounded.

The phase detection circuit 95 includes a multiplier 91 which receives output of the wave detector 72, a 90-degree phase shifter 92 which shifts a phase of the output wave detector 72, and a lowpass filter (LPF) 93 which receives output of the multiplier 91. The wide-band AFC circuit 96 includes a direct-current inverting amplifier 94 which receives output of the lowpass filter 93 and VCO 67 which receives output of the direct-current inverting amplifier 94 to supply a local signal.

The output end of the wave detector 72 is also connected to an input end of the direct-current amplifier 73, an output end of the direct-current amplifier 73 is connected to one of input ends of the comparator 74, and a fixed detection reference voltage E0 is applied to the other input end of the comparator 74. An output end of the comparator 74 is connected to the relay excitation coil 75, the relay contact 76 of the relay excitation coil 75 is connected to a monitoring line 77, and the power supply 78 is connected to the monitoring line 77.

An output end of the wave detector 72 is connected to an input end of an Analogue/Digital (A/D) converter 79 too, and an output end of the A/D converter 79 is connected to a Digital/Analogue (D/A) converter 81 through a digital gate 80. The output end of the direct-current amplifier 73 is connected to one of input ends of a comparator 82, an AGC reference voltage E1 is applied to the other input end of the comparator 82, and an output end of the comparator 82 is connected to a gate control voltage of the digital gate 80. An output end of the D/A converter 81 is connected to a control voltage of the amplifier 68 and a control voltage of the amplifier 70.

In the phase detection circuit 95, the output end of the wave detector 72 is connected to one of input ends of the multiplier 91 and an input end of the 90-degree phase shifter (θ=90°) 92, an output end of the 90-degree phase shifter 92 is connected to the other input end of the multiplier 91. An output end of the multiplier 91 is connected to an input end of the direct-current inverting amplifier 94 through LPF 93, and an output end of the direct-current inverting amplifier 94 is connected to a control voltage input end of VCO 67.

FIG. 4 shows a configuration of the phase shifter 92 by way of example. The phase shifter 92 includes a resistor 111 which is connected to the input end of the phase shifter 92, a resistor 112, a capacitor 114 in which one end is grounded while the other end is connected to the resistor 112, a resistor 113 in which one end is connected to the other end of the resistor 111 while the other end is connected to the output end of the phase shifter 92, and a comparator 115. In the comparator 115, a first input end is connected to the other end of the resistor 111, a second input end is connected to the other end of the resistor 112, and an output end is connected to the output end of the phase shifter 92.

The AGC circuit 87 includes the comparator 82 which receives the output of the direct-current amplifier 73, the A/D converter 79 which receives the output of the wave detector 72, the digital gate 80 which opens and closes the output of the A/D converter 79, and the D/A converter 81 which converts and supplies the output of the digital gate 80.

(Operation)

The microwave sensor system 10 having the above-described configuration is operated as follows. The transmission antenna 63 and the reception antenna 64 are disposed on both sides of a detection area 89 while facing each other. A microwave signal generated from the microwave oscillator 61 is transmitted into the air from the transmission antenna 63 after amplified by the amplifier 62. For example, the microwave signal has a frequency of 24.15 GHz. The radio microwave signal is always transmitted in the air from the transmitter 83. A microwave signal fr received by the reception antenna 64, is selectively amplified by the amplifier 65, the microwave signal fr is fed into one of the input ends of the mixer 66. A local signal flo having a local frequency is supplied from the other input end of the mixer 66 from VCO 67 of the local oscillator. In the mixer 66, the microwave signal fr and the local signal flo having the local frequency are mixed to perform frequency conversion, and an intermediate frequency signal fif having an intermediate frequency is supplied to the output end of the mixer 66. The intermediate frequency signal fif supplied from the mixer 66 is amplified by the amplifier 68 and fed into the filter amplifier 84.

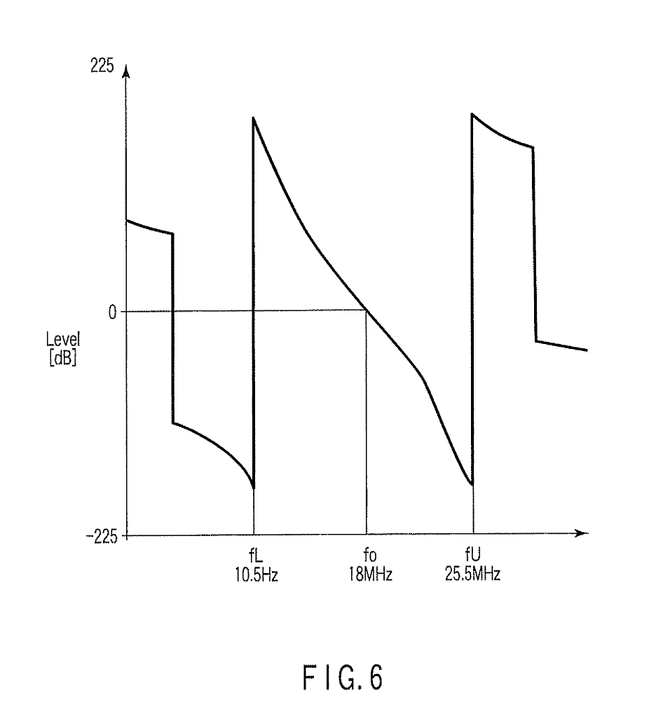

An output characteristic (phase characteristic) of the filter amplifier 84 exerts a transmission characteristic, as shown in FIG. 6 the phase is continuously shifted between an upper limit frequency fU and a lower limit frequency fL of the reception band by the action of the filters 69 and 71 of the filter amplifier 84, and the phase progress direction is inverted when reaching the upper limit frequency fU or lower limit frequency fL of the reception band. An output characteristic (phase shift characteristic) of the 90-degree phase shifter 92 is that the frequency becomes lower than central frequency F0, the phase shift becomes greater than 90°. Conversely, as the frequency becomes higher than central frequency F0, the phase shift becomes less than 90°. Therefore, the phase difference between the input signal supplied to the 90-degree phase shifter 92 and an output signal supplied from the filter amplifier 84 increases when the frequency becomes closer to the lower limit frequency fL, and decreases when the frequency becomes closer to the upper limit frequency fU. An output signal from the filter amplifier 84 is detected (rectified) by the wave detector (rectifier) 72 and supplied as a detection output signal s1.

The reception detection signal s1 sent from the reception detection circuit 85 to the AGC circuit 87 is converted into the analog signal by the A/D converter 79, and sent to the D/A converter 81 through the digital gate 80. The ON/OFF control of the digital gate 80 is performed by the signal supplied from the comparator 82. At this point, the digital gate 80 is controlled so as to be in the ON state when the intruder does not exist in the detection area 89, and the digital gate 80 is controlled so as to be in the OFF state when the intruder exists.

The comparator 82 compares the AGC reference voltage E1 with the reception detection signal supplied from the direct-current amplifier 73, and the output level of the comparator 82 is changed to “high” or “low” according to the presence or absence of the intruder. When the intruder does not exist in the detection area 89, the level of the reception detection signal b supplied from the direct-current amplifier 73 is higher than that of the AGC reference voltage E1, and the output of the comparator 82 becomes “high” to maintain the digital gate 80 in the ON state.

However, when the intruder exists in the detection area 89, the level of the reception detection signal b supplied from the direct-current amplifier 73 is lower than that of the AGC reference voltage E1, and the output of the comparator 82 becomes “low” to turn off the digital gate 80.

Thus, the ON/OFF control of the digital gate 80 is performed by the presence or absence of the intruder in the detection area 89.

As described above, when the intruder does not exist in the detection area 89, the comparator 82 supplies the “high” level signal, therefore, the digital gate 80 is kept in the ON state. Therefore, the digital signal supplied from the A/D converter 79 is sent to the D/A converter 81 through the digital gate 80, and the digital signal is converted into the analog signal to continuously produce the AGC voltage. The AGC voltage is send to the reception detection circuit 85, and adjusts the gain of the amplifier 68, 70.

(Operation of Wide-Band AFC Circuit)

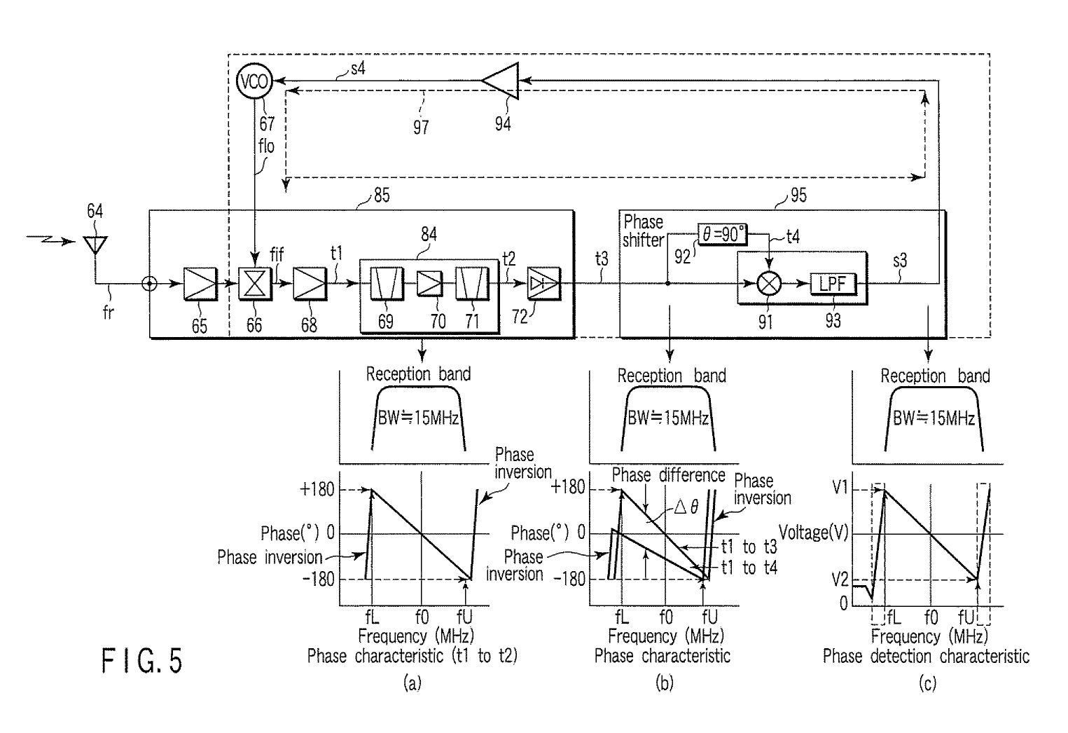

An operation of the wide-band AFC circuit 96 will be described below. FIG. 5 is a view explaining the operation of the wide-band AFC circuit of the embodiment.

As shown in FIG. 5, the microwave signal fr having the reception frequency (24.15 GHz±7.5 MHz), received by the reception antenna 64, is selectively amplified by the amplifier 65, the microwave signal fr is fed into one of the input ends of the mixer 66, and the local signal flo having the frequency is fed into the other input end of the mixer 66 from VCO 67. In the mixer 66, the microwave signal fr having the reception frequency and the local signal flo having the local frequency are mixed to perform frequency conversion, and the intermediate frequency signal fif having the intermediate frequency is supplied from the output end of the mixer 66. The intermediate frequency signal fif (about 18 MHz) supplied from the mixer 66 is amplified by the amplifier 68 and fed into the filter amplifier 84.

It is assumed that the input end of the filter amplifier 84 is set at t1, the output end of the filter amplifier 84 is set at t2, the output end of the wave detector (rectifier) 72 is set at t3, and the output end of the 90-degree phase shifter 92 is set at t4. As shown in FIG. 5A, for the phase characteristic of t1 and t2 of the intermediate frequency signal fif supplied from the mixer 66, the phase is continuously shifted between an upper limit frequency fU (25.5 MHz) (phase: about −180°), a frequency f0 (18 MHz) and a lower limit frequency fL (10.5 MHz) (phase: about +180°) of the reception band (BW≈15 MHz, BW≈10.5 MHz, BW≈25.5 MHz because 18 MHz±7.5 MHz) by the action of the filters 69 and 71 of the filter amplifier 84, and the phase is inverted at the upper limit frequency fU and the lower limit frequency fL out of the reception band (BW≈15 MHz). The phase characteristic is fed as the transmission characteristic into the phase detection circuit 95 through the wave detector (rectifier) 72. In the phase detection circuit 95, the output signal of the reception detection circuit 85 is fed into one of the input ends of the multiplier 91, and the output signal of the reception detection circuit 85 is fed into the other input end of the multiplier 91 while the 90-degree phase shifter (θ=90°) 92 delays the phase by 90°.

As a result, as shown in FIG. 5B, there is generated a phase difference between the phase characteristic of t1 to t3 and the phase characteristic of t1 to t4. That is, the characteristic fed into the multiplier 91 has the phase difference which is inversely proportional to the frequency of the intermediate frequency signal such that a phase difference Δθ becomes smaller at the upper limit frequency fU of the reception band while the phase difference Δθ becomes larger at the lower limit frequency fL of the reception band In the multiplier 91, the intermediate frequency signal which is the output signal of the reception detection circuit 85 and the signal in which the phase of the intermediate frequency signal which is the output signal of the reception detection circuit 85 is shifted by 90° are multiplied and passed through LPF 93, whereby a direct-current phase detection output voltage s3 corresponding to the phase difference which is inversely proportional to the frequency of the reception band is obtained at the output end LPF 93.

As shown in FIG. 5C, the phase detection output voltage s3 becomes a voltage V located between the upper limit frequency fU (voltage V2) and lower limit frequency fL (voltage V1) of the reception band. The direct-current inverting amplifier 94 performs direct-current inverting amplification of the phase detection output voltage s3 to obtain an AFC voltage s4, the AFC voltage s4 is fed into VCO 67, and the oscillation frequency flo of VCO 67 is fed into mixer 66 under control. Accurate tracks of a phase detection output voltage is shown in FIG. 6.

The AFC loop 97 of VCO 67→mixer 66→filter amplifier 84→phase detection circuit 95→direct-current inverting amplifier 94→VCO 67 is repeated, and finally the output of VCO 67 is operated while following the transmission frequency of the transmitter 83. Therefore, the intermediate frequency of the receiver 88 is controlled so as to be kept constant even if the frequency of the microwave oscillator 61 used in the transmitter 83 is changed, so that the detection output signal s1 can be obtained from the reception detection circuit 85.

As shown in FIG. 5C, the phase detection output voltage s3 out of the reception band surrounded by dotted lines has the opposite slop to those of the frequency following voltages at the upper limit frequency fU and lower limit frequency fL of the reception band. Therefore, when the phase detection output voltage s3 out of the reception band is given to the wide-band AFC circuit 96, the phase detection output voltage s3 cannot follow the transmission frequency of the transmitter 83 to diverge, self-channel within the reception band is withdrawn, and the adjacent channels out of the reception band is not withdrawn.

A phase shifter which progresses the phase by 90° may be used as the 90-degree phase shifter 92. In such cases, a direct-current amplifier is used instead of the direct-current inverting amplifier 94.

The feature of the microwave sensor system of the embodiment is summarized as follows. The microwave sensor system 10 includes the transmitter 83 which sends the microwave and the receiver 88 which receives the microwave. The receiver 88 includes the reception detection circuit 85 which performs the wave detection of the received microwave to supply the wave detection output, the AGC circuit 87 which receives the wave detection output to control the gain of the wave detection circuit, and the monitoring means 73, 74, and 86 for sending the invasion alarm when the wave detection output is changed larger than the predetermined value.

The receiver 88 has the following feature such that the frequency is automatically follows the radio wave emitted from the microwave transmitter in order to automatically correct the fluctuation in frequency caused by the temperature characteristic of the oscillator used in the transmitter. In the receiver 88, the reception input of the reception antenna is selectively amplified, and the frequency conversion is performed to produce the intermediate frequency signal. At this point, the intermediate frequency signal is passed through the filters 69 and 71 which are the elliptic function filter amplifier such that, in the phase characteristic of the intermediate frequency signal, the phase is continuously shifted between the upper limit frequency fU and lower limit frequency fL of the reception band, such that the phase is inverted at the upper limit frequency fU and lower limit frequency fL, and such that the phase difference is generated when the intermediate frequency signal is fed into the 90-degree phase shifter 92. Additionally, the phase detection circuit 95 is provided. In the phase detection circuit 95, the output of the reception detection circuit 85 is added to the input of the multiplier 91, and the output of the reception detection circuit 85 is phase-shifted by 90 degrees and added to the other input of the multiplier 91 to supply the average voltage proportional to the phase difference between the two signals. The wide-band AFC circuit 96 is also provided. The wide-band AFC circuit 96 automatically follows the transmitter frequency by giving the voltage output of the phase detection circuit 95 to the voltage control oscillator 67. The output of the wide-band AFC circuit 96 is given to the mixer 66 to eliminate the influence of the fluctuation in frequency caused by the temperature characteristic of the oscillator. The phase is inverted at the upper limit frequency and lower limit frequency of the reception band to eliminate the withdrawal of the adjacent channels, and the reception detection band is narrowed to increase the number of the frequency division channels.

Accordingly, in the microwave sensor system of the embodiment, plural channels are set in the specified band, the invasion detection sensors can vertically be placed in a multistage manner, and the invasion detection sensors can be placed at a corner in an overlapping manner The monitoring area can surely be monitored within an expected temperature range.

The invention is not limited to the embodiment, but various modifications of the constituents can be made in the implementation stage without departing from the scope of the invention. Various inventions can also be made by appropriately combining plural constituents disclosed in the embodiments. For example, some constituents may be eliminated from all the constituents disclosed in the embodiment. Additionally, the constituents of the different embodiments may appropriately be combined.

What is claimed is:

1. A microwave receiver comprising:
a local transmitter which supplies a local signal having a frequency according to a supplied voltage;
a mixer which combines a received microwave signal with the local signal to supply an intermediate frequency signal;
a filter which passes the intermediate frequency signal;
a phase shifter which shifts a phase of the intermediate frequency signal passed through the filter by a predetermined angle; and
a phase detection unit which supplies a voltage to the local oscillator according to a phase difference between the intermediate frequency signal passed through the filter and output of the phase shifter.

2. The microwave receiver according to claim 1, wherein the filter is an elliptic function filter.

3. The microwave receiver according to claim 1, wherein an output characteristic of the filter is set such that the phase is continuously shifted from a lower limit frequency of the intermediate frequency to an upper limit frequency of the intermediate frequency.

4. The microwave receiver according to claim 1, wherein a phase characteristic of the phase shifter is set such that a difference with the predetermined angle is continuously changed from a lower limit frequency of the intermediate frequency to an upper limit frequency of the intermediate frequency.

5. A microwave sensor system comprising:
a transmitter which transmits a microwave from a transmission antenna, the transmission antenna being disposed one side of a detection area; and
a receiver which includes a reception antenna, the reception antenna being disposed on the other side of the detection area while facing the transmission antenna, the receiver having:
a local transmitter which supplies a local signal having a frequency according to a supplied voltage;
a mixer which combines a received microwave signal with the local signal to supply an intermediate frequency signal;
a filter which passes the intermediate frequency signal;
a phase shifter which shifts a phase of the intermediate frequency signal passed through the filter by a predetermined angle; and
a phase detection unit which supplies a voltage to the local oscillator according to a phase difference between the intermediate frequency signal passed through the filter and output of the phase shifter.

6. The microwave sensor system according to claim 5, wherein the filter is an elliptic function filter.

7. The microwave sensor system according to claim 5, wherein a phase characteristic of the phase shifter is set such that a difference with the predetermined angle is continuously changed from a lower limit frequency of the intermediate frequency to an upper limit frequency of the intermediate frequency.

8. The microwave sensor system according to claim 5, wherein a phase characteristic of the phase shifter is set such that a difference with the predetermined angle is continuously changed from a lower limit frequency of the intermediate frequency to an upper limit frequency of the intermediate frequency.
